(19) United States
(12) Patent Application Publication
(10) Pub. No.: US 2010/0117942 A1
(43) Pub. Date: May 13, 2010

(54) LIQUID CRYSTAL DISPLAY

(76) Inventor: Tsuyoshi Kamada, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/613,885

(22) Filed: Nov. 6, 2009

(30) Foreign Application Priority Data
Nov. 6, 2008 (JP) P2008-285305

(51) Int. Cl. G09G 3/36

(52) U.S. Cl. 345/88

(57) ABSTRACT

A first sub-pixel allows at least first primary color light and second primary color light to pass therethrough, and a second sub-pixel allows at least the second primary color light and third primary color light to pass therethrough. In a first drive period, a drive section drives a light source section to separately emit the first primary color light and the third primary color light, and the drive section drives the first sub-pixel and the second sub-pixel in response to a picture signal for the first primary color light and a picture signal for the third primary color light, respectively, and in a second drive period, the drive section drives the light source section to emit the second primary color light, and the drive section drives the first and second sub-pixels in response to a picture signal for the second primary color light.

### BACKGROUND OF THE INVENTION

1. Field of the Invention

The present invention relates to a liquid crystal display using a color filter (CF) to perform color display. 2. Description of the Related Art

In recent years, liquid crystal displays (LCDs) are commonly used as display monitors for liquid crystal televisions, notebook computers, car navigation systems and the like. A typical liquid crystal display uses a color filter to perform full-color display.

FIG. 17 illustrates an example of a color filter used for such full-color display. In this case, a red (R) color filter 103R, a green (G) color filter 103G or a blue (B) color filter 103B corresponding to three primary colors of light is arranged on each of pixels 102. Luminance in each of such pixels 102 is controlled by the color filter 103R, 103G or 103B so as to allow full-color display.

However, light is spatially divided into three colors by the color filters 103R, 103G and 103B, so light which is spatially effectively usable is only approximately 33% of incident light. Moreover, the transmittance of light having an optimum wavelength through each of the color filters 103R, 103G and 103B is only approximately 70 to 80%, so with all things considered, only approximately 25% of the incident light is usable. In addition, the other 75% or over of the incident light is converted into heat in the color filters 103R, 103G and 103B.

Therefore, as a technique for solving an issue of such low light use efficiency, a field-sequential (time-division) drive has been heretofore proposed as described in, for example, Japanese Unexamined Patent Application Publication No. 2003-280614 and Yi-Fu Chen, et al., “Mixed Color Sequential Technique for High Contrast LCD with Optimum Power Consumption”, SID′07, p. 134, 2007. In the field-sequential drive, light sources allowed to emit light of RGB colors, respectively, such as LEDs (Light Emitting Diodes) are used, and full-color display is performed by temporally switching among light of RGB colors. In such a field-sequential system, the above-described color filters are not necessary (refer to FIG. 18), so it is considered that 4 or more times higher light use efficiency is obtained in the field-sequential system.

### SUMMARY OF THE INVENTION

FIG. 18 illustrates an example of a pixel configuration in a field-sequential system in related art. Each of pixels 202 is a colorless pixel on which a color filter is not arranged as described above, and data of RGB colors are line-sequentially written to the pixels 202 in order of RGB, and a backlight emits light of RGB colors in order of RGB in synchronization with these data.

However, in such a field-sequential system, light use efficiency is high, but a temporally effective period is approximately ⅙ or less of one frame period, so to obtain a certain luminance, it is necessary for the backlight to have the maximum luminance which is higher than that in related art. For example, in the case where LEDs are used, a larger number of LEDs than that in related art are necessary, thereby it is disadvantageous in terms of costs. Moreover, the LEDs tend to reduce their light emission amounts relative to electric power according to a reduction in duty ratio when the LEDs light up, so even if light use efficiency is improved, power efficiency is reduced.

Moreover, a fundamental issue in the field-sequential system is a so-called color breakup phenomenon. In the color breakup phenomenon, when time-divided images are focused on the same position on a retina, colors are correctly superimposed, but depending on the movement of an object or an eye when watching motion pictures, the time-divided images are focused on different positions on the retina without intention, thereby RGB colors are separately seen. To suppress such a color breakup phenomenon, for example, in a DLP (Digital Light Processing) or the like as a projector using a DMD (Digital Micromirror Device), performing a sextuple-speed drive or the like which is a faster drive is considered, but it is difficult to take similar measures in a liquid crystal which is slow in response.

It is desirable to provide a liquid crystal display allowing an improvement in image quality in color display while enhancing light use efficiency and power efficiency.

According to an embodiment of the invention, there is provided a liquid crystal display including: a light source section allowed to separately emit first primary color light, second primary color light and third primary color light in different wavelength regions; a liquid crystal display panel including a plurality of pixels arranged in a matrix form as a whole, and modulating each of the first primary color light, the second primary color light and the third primary color light emitted from the light source section in response to a picture signal, each of the plurality of pixels including a first sub-pixel and a second sub-pixel; and a drive section driving the light source section and each sub-pixel in the liquid crystal display panel in response to the picture signal so as to include a first drive period and a second drive period in one vertical period time-dividedly. In this case, the above-described first sub-pixel allows at least the first primary color light and the second primary color light to pass therethrough, and the above-described second sub-pixel allows at least the second primary color light and the third primary color light to pass therethrough. Moreover, in the above-described first drive period, the above-described drive section drives the light source section to separately emit the first primary color light and the third primary color light, and the drive section drives the first sub-pixel and the second sub-pixel in response to a picture signal for the first primary color light and a picture signal for the third primary color light, respectively, and in the above-described second drive period, the drive section drives the light source section to emit the second primary color light, and the drive section drives the first and second sub-pixels in response to a picture signal for the second primary color light.

In the liquid crystal display according to the embodiment of the invention, in the first sub-pixel period, the first primary color light and the third primary color light are emitted from the light source section, and then the first primary color light is selectively modulated in the first sub-pixel in response to the picture signal for the first primary color light to display a picture by the first primary color light, and the third primary color light is selectively modulated in the second sub-pixel in response to the picture signal for the third primary color light to display a picture by the third primary color light. Moreover, in the second drive period, the second primary color light emitted from the light source section is selectively modulated in the first and second sub-pixels in response to the picture signal for the second primary color light to display a picture by the second primary color light. Then, such first and second drive periods are included in one vertical period time-dividedly, so full-color display corresponding to the picture signal for each primary color light is performed. At this time, in the first drive period, the first primary color light and the third primary color light are emitted from the light source section, and in the second drive period, the second primary color light is emitted from the light source section, thereby each primary color light emission period (a lighting-up period) in one vertical period is longer than that in a field-sequential system in related art. Moreover, in the second drive period, only the second primary color light is emitted, and is modulated in both of the first and second sub-pixels, so compared to a three-primary-color filter system in related art, an aperture ratio in full-color display is improved. Further, in the first drive period, both of the first primary color light and the third primary color light are emitted, so the occurrence of a color breakup phenomenon is prevented.

In the liquid crystal display according to the embodiment of the invention, in the first drive period, the first primary color light and the third primary color light are emitted from the light source section, and in the second drive period, the second primary color light is emitted from the light source section, so each primary color light emission period (a lighting-up period) in one vertical period is allowed to be longer than that in the field-sequential system in related art, and an improvement in duty ratio is allowed. Moreover, in the second drive period, only the second primary color light is emitted, and is modulated in both of the first and second sub-pixels, so compared to the three-primary-color filter system in related art, an improvement in aperture ratio in full-color display is allowed. Further, in the first drive period, both of the first primary color light and the third primary color light are emitted, so the occurrence of a color breakup phenomenon is preventable. Therefore, while light use efficiency and power efficiency are enhanced, an improvement in image quality in color display is allowed.

Other and further objects, features and advantages of the invention will appear more fully from the following description.

### BRIEF DESCRIPTION OF THE DRAWINGS

FIG. 1 is a block diagram illustrating the whole configuration of a liquid crystal display according to an embodiment of the invention.

FIG. 2 is a schematic plan view illustrating a specific configuration example of a backlight section illustrated in FIG. 1.

FIG. 3 is a circuit diagram illustrating a specific configuration example of a pixel illustrated in FIG. 1.

FIG. 4 is a plan view illustrated in a configuration example of a color filter arranged in each sub-pixel in the pixel illustrated in FIG. 3.

FIG. 5 is a timing chart for describing a method of displaying a picture by a field-sequential system in related art according to Comparative Example 1.

FIG. 6 is a timing chart for describing a method of displaying a picture by a field-sequential system in related art according to Comparative Example 2.

FIG. 7 is a timing chart for describing a method of displaying a picture in the liquid crystal display according to the embodiment.

FIGS. 8A and 8B are schematic views for describing details of the method of displaying a picture illustrated in FIG. 7.

FIG. 9 is a timing chart for describing a method of displaying a picture according to Modification 1 of the invention.

FIG. 10 is a timing chart for describing a method of displaying a picture according to Modification 2 of the invention.

FIG. 11 is a timing chart for describing a method of displaying a picture according to Modification 3 of the invention.

FIGS. 12A and 12B are schematic views for describing details of the method of displaying a picture illustrated in FIGS. 10 and 11.

FIG. 13 is a plan view illustrating a configuration example of a color filter according to Modification 4 of the invention.

FIGS. 14A and 14B are schematic plan views for describing a vertical streak phenomenon when displaying a picture.

FIG. 15 is a circuit diagram illustrating a configuration of a pixel according to Modification 5 of the invention.

FIG. 16 is a timing waveform chart illustrating an example of a driving method in the configuration of the pixel illustrated in FIG. 15.

FIG. 17 is a plan view illustrating a configuration example of a color filter used in a liquid crystal display in related art.

FIG. 18 is a plan view illustrating a configuration example of a color filter used in a method of displaying an image by a field-sequential system in related art.

### DETAILED DESCRIPTION OF THE PREFERRED EMBODIMENTS

A preferred embodiment will be described in detail below referring to the accompanying drawings.

The Whole Configuration Example of Liquid Crystal Display

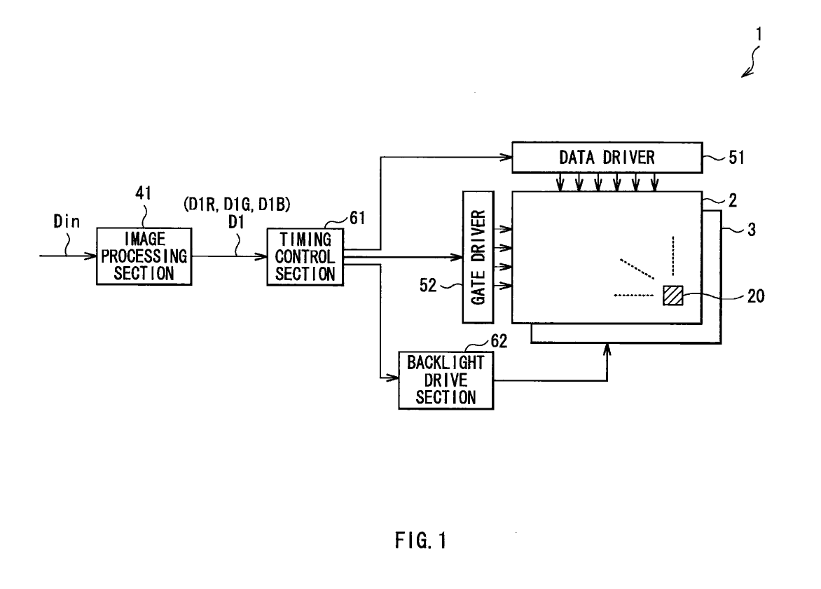

FIG. 1 illustrates the whole configuration of a liquid crystal display (a liquid crystal display 1) according to an embodiment of the invention. The liquid crystal display 1 includes a liquid crystal display panel 2, a backlight section 3, an image processing section 41, a data driver 51, a gate driver 52, a timing control section 61 and a backlight drive section 62.

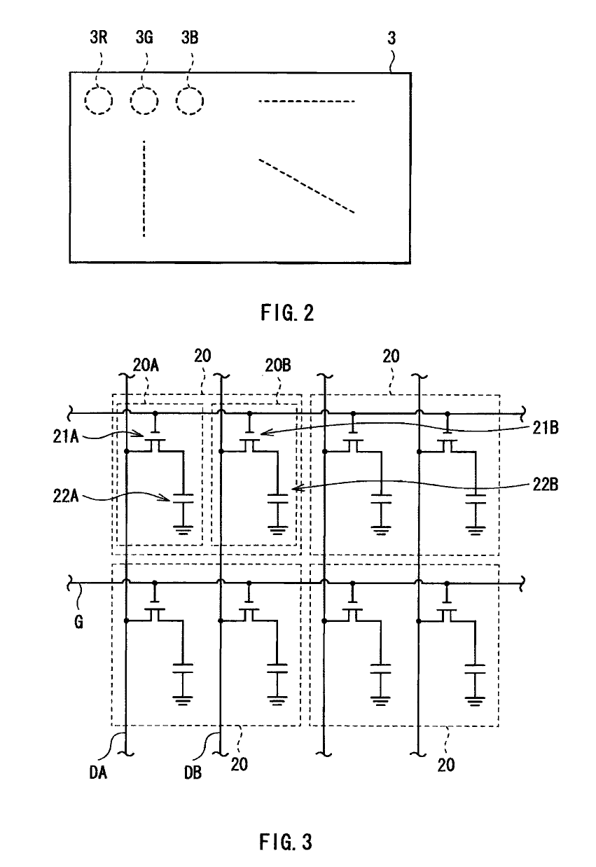

The backlight section 3 is a light source applying light to the liquid crystal display panel 2, and includes, for example, LEDs or the like. The backlight section 3 is allowed to separately emit light of three primary colors in different wavelength regions (red light (first primary color light), green light (second primary color light) and blue light (third primary color light)). More specifically, for example, as illustrated in FIG. 2, the backlight section 3 includes red light sources 3R, green light sources 3G and blue light sources 3B.

The liquid crystal display panel 2 modulates light emitted from the backlight section 3 based on a drive voltage supplied from the data driver 51 in response to a drive signal supplied from the gate driver 52 which will be described later to display a picture corresponding to a picture signal Din. The liquid crystal display panel 2 includes a plurality of pixels 20 arranged in a matrix form as a whole.

The image processing section 41 performs predetermined image processing on the picture signal Din from outside to produce a picture signal D1 which is an RGB signal.

The gate driver 52 line-sequentially drives each pixel 20 in the liquid crystal display panel 2 along a scanning line (a gate line G which will be described later) according to timing control by the timing control section 61.

The data driver 51 supplies a drive voltage corresponding to the picture signal D1 supplied from the timing control section 61 to each pixel 20 of the liquid crystal display panel 2. More specifically, the data driver 51 performs D/A conversion on the picture signal D1 to produce a picture signal (the above-described drive voltage) as an analog signal and output the picture signal to each pixel 20. In addition, the picture signal D1 includes red data D1R, green data D1G and blue data D1B.

The backlight drive section 62 controls the lighting operation (light emission operation) of the backlight section 3. The timing control section 61 controls driving timings of the gate driver 52 and the data driver 51, and supplies the picture signal D1 to the data driver 51.

Specific Configuration Example of Pixel

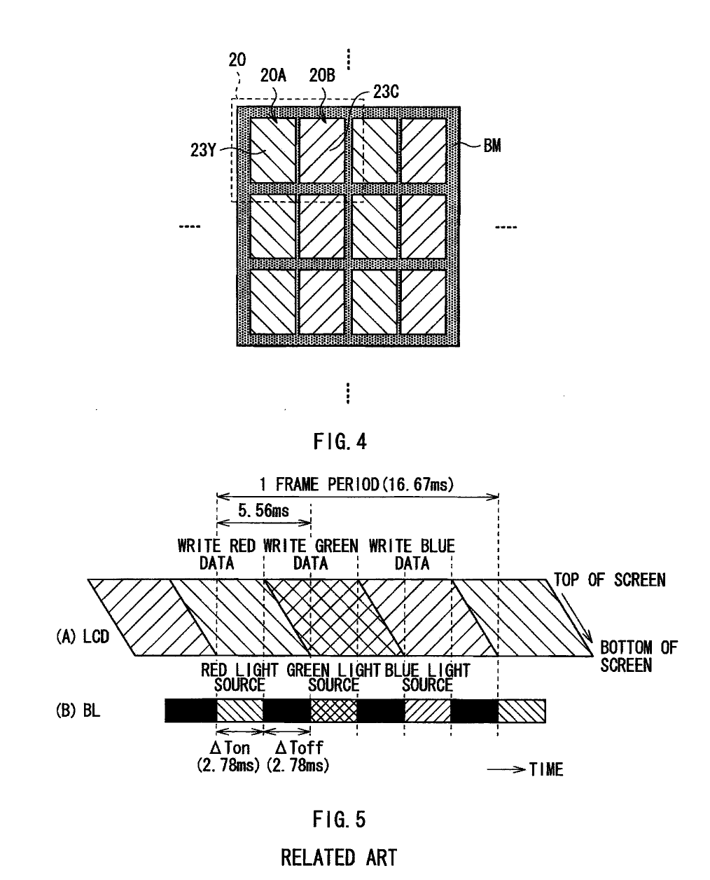

Next, referring to FIGS. 3 and 4, a specific configuration of each pixel 20 will be described in detail below. FIG. 3 illustrates a circuit configuration example of a pixel circuit in each pixel 20.

Each pixel 20 includes two sub-pixels 20A and 20B. The sub-pixel 20A includes a liquid crystal device 22A and a thin film transistor (TFT) device 21A. On the other hand, the sub-pixel 20B includes a liquid crystal device 22B and a TFT device 21B. Moreover, one gate line G for line-sequentially select a pixel to be driven and two data lines DA and DB for supplying a drive voltage (the drive voltage supplied from the data driver 51) to the sub-pixels 20A and 20B in the pixel to be driven, respectively, are connected to each pixel 20.

The liquid crystal device 22A functions as a display element of performing an operation for display (emitting display light) in response to the drive voltage supplied from the data line DA to one end thereof through the TFT device 21A. On the other hand, the liquid crystal device 22B functions as a display element of performing an operation for display (emitting display light) in response to the drive voltage supplied from the data line DB to one end thereof through the TFT device 21B. The liquid crystal devices 22A and 22B each include a liquid crystal layer (not illustrated) formed of, for example, a VA (Vertical Alignment) mode or TN (Twisted Nematic) mode liquid crystal, and a pair of electrodes (not illustrated) between which the liquid crystal layer is sandwiched. One of the pair of electrodes in the liquid crystal device 22A (one end of the liquid crystal device 22A) is connected to a drain of the TFT device 21A, and the other electrode (the other end of the liquid crystal device 22A) is connected to a ground. Moreover, one of the pair of electrodes in the liquid crystal device 22B (one end of the liquid crystal device 22B) is connected to a drain of the TFT device 21B, and the other electrode (the other end of the liquid crystal device 22B) is connected to a ground.

The TFT device 21A includes a MOS-FET (Metal Oxide Semiconductor-Field Effect Transistor), and in the TFT device 12A, a gate is connected to the gate line G, and a source is connected to the data line DA, and a drain is connected to the one end of the liquid crystal device 22A. The TFT device 21A functions as a switching device for supplying a drive voltage for the sub-pixel 20A (a drive voltage corresponding to the picture signal D1) to the one end of the liquid crystal device 22A. More specifically, the TFT device 21A selectively provides conduction between the data line DA and the one end of the liquid crystal device 22A in response to a selection signal supplied from the gate driver 52 through the gate line G.

On the other hand, the TFT device 21B also includes a MOS-FET, and in the TFT device 21B, a gate is connected to the gate line G, a source is connected to the data line DB, and a drain is connected to the one end of the liquid crystal device 22B. The TFT device 21B functions as a switching device for supplying a drive voltage for the sub-pixel 20B (a drive voltage corresponding to the picture signal D1) to the one end of the liquid crystal device 22B. More specifically, the TFT device 21B selectively provides conduction between the data line DB and the one end of the liquid crystal device 22B in response to a selection signal supplied from the gate driver 52 through the gate line G.

Moreover, as illustrated in FIG. 4, in the embodiment, the sub-pixel 20A includes a yellow (Y) color filter 23Y, and at least red light and green light are allowed to pass through the sub-pixel 20A. On the other hand, the sub-pixel 20B includes a cyan (C) color filter 23C, and at least green light and blue light are allowed to pass through the sub-pixel 20B.

The timing control section 61, the backlight drive section 62, the data driver 51 and the gate driver 52 correspond to specific examples of “a drive section” in the invention. The sub-pixel 20A corresponds to a specific example of “a first sub-pixel” in the invention, and the sub-pixel 20B corresponds to a specific example of “a second sub-pixel” in the invention.

Next, functions and effects of the liquid crystal display 1 according to the embodiment will be described below.

Basic Operation of Liquid Crystal Display

First, referring to FIGS. 1 to 3, the basic operation of the liquid crystal display 1 will be described below.

In the liquid crystal display 1, as illustrated in FIG. 1, the image processing section 41 performs image processing on the picture signal Din supplied from outside to produce the picture signal D1 for each pixel 20. Then, the picture signal D1 is supplied to the data driver 51 through the timing control section 61. In the data driver 51, D/A conversion is performed on the picture signal D1 to produce a picture signal as an analog signal. Then, a display drive operation is line-sequentially performed on each pixel 20 in response to the picture signal by drive voltages outputted from the gate driver 52 and the data driver 51 to each pixel 20.

More specifically, as illustrated in FIG. 3, switching between operating/nonoperating (ON/OFF) states of the TFT devices 21A and 21B is performed in response to a selection signal supplied from the gate driver 52 through the gate line G. Thereby, conduction between the data line DA and the liquid crystal device 22A and conduction between the data line DB and the liquid crystal device 22B are selectively provided. As a result, a drive voltage corresponding to the picture signal supplied from the data driver 51 is supplied to the liquid crystal devices 22A and 22B to perform the display drive operation.

Then, in the pixel 20 in which conduction between the data line DA and the liquid crystal device 22A and conduction between the data line DB and the liquid crystal device 22B are provided, illumination light from each of the light sources 3R, 3G and 3B in the backlight section 3 illustrated in FIG. 2 is modulated in the liquid crystal display panel 2 to be emitted as display light. Thereby, a picture corresponding to the picture signal Din is displayed on the liquid crystal display 1.

Specific Example of Method of Displaying a Picture in Liquid Crystal Display

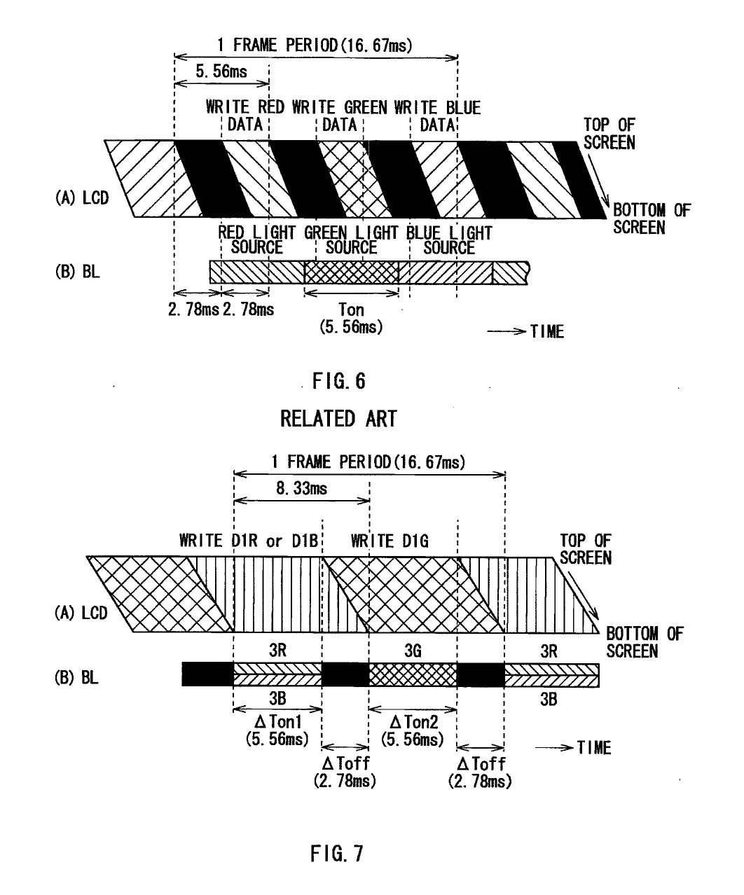

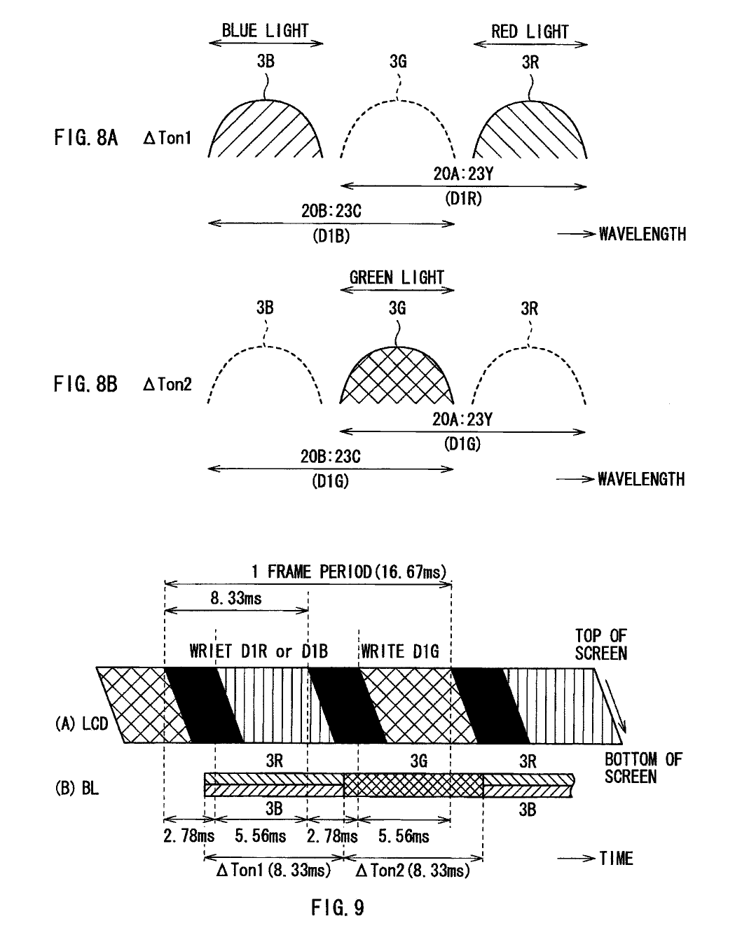

Next, referring to FIG. 5 to FIGS. 8A and 8B, a method of displaying a picture (a color display method) as one of characteristic points of the invention will be described in detail compared to comparative examples. FIGS. 5 and 6 illustrate timing charts of methods of displaying a picture by a field-sequential system in related art according to Comparative Examples 1 and 2. Moreover, FIG. 7 and FIGS. 8A and 8B illustrate a timing chart and schematic views of a method of displaying a picture in the liquid crystal display 1 according to the embodiment, respectively. In addition, in FIGS. 5 to 7 and subsequent drawings, (A) illustrates a picture signal (each color data) writing operation state in the liquid crystal display panel, and (B) illustrates lighting-up/off states of each color light source in the backlight section.

First, in a color display method using color filters of three primary colors in related art illustrated in FIG. 17, light is spatially divided into three colors by color filters 103R, 103G and 103B, so light which is spatially effectively usable is only approximately 33% of incident light. Moreover, the transmittance of light having an optimum wavelength through each of the color filters 103R, 103G and 103B is only approximately 70 to 80%, so with all things considered, only approximately 25% of the incident light is usable. In addition, the other 75% or over of the incident light is converted into heat in the color filters 103R, 103G and 103B.

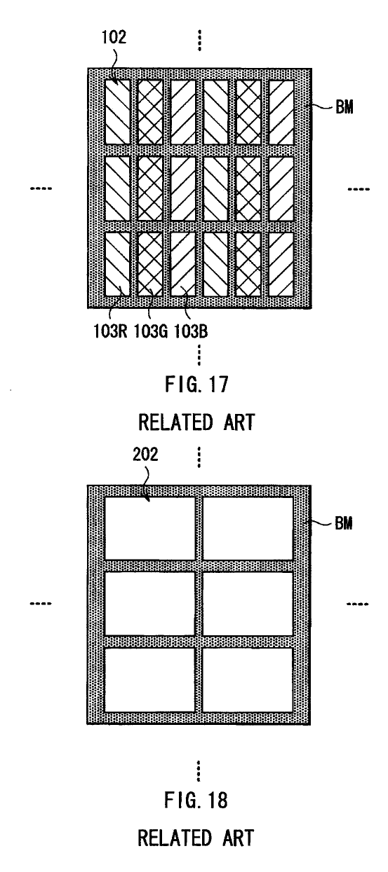

On the other hand, in Comparative Example 1 illustrated in FIG. 5, as illustrated in FIG. 18, each pixel 202 is a colorless pixel on which the color filter is not arranged, and data of RGB colors are line-sequentially written to the pixels 202 in order of RGB, and a backlight emits light of RGB colors in order of RGB in synchronization with these data. In a backlight-on period ΔTon in the drawing, data for a single color is written on the whole screen, so the backlight is allowed to emit light of a color corresponding to the single color. On the other hand, a backlight-off period ΔToff is a transition period to the next single color, so in the period ΔToff, data of a different color is present on the screen at the same time. Therefore, to prevent the colors from being mixed, in the period ΔToff, the backlight is not allowed to emit light. In the case of a normal 60-Hz drive, one frame period (one vertical period) is 16.6 ms, but in the case where the period is divided into RGB by the field-sequential system, each sub-frame period is 5.56 ms. Therefore, even if writing to the liquid crystal and the response of the liquid crystal are completed within 2.78 ms which is ½ of the sub-frame period, a period in which the backlight is allowed to emit light is only 2.78 ms. In addition, in the case where writing to the liquid crystal or the response of the liquid crystal is slow, the lighting-up period is further reduced.

Thus, in Comparative Example 1, although light use efficiency is high, a temporally effective period is approximately ⅙ or less of the one frame period, so to obtain a certain luminance, it is necessary for the backlight to have the maximum luminance which is higher than that in related art. For example, in the case where LEDs are used, a larger number of LEDs than that in related art are necessary, thereby it is disadvantageous in terms of costs. Moreover, the LEDs tend to reduce their light emission amounts relative to electric power according to a reduction in duty ratio when the LEDs light up, so even if light use efficiency is improved, power efficiency is reduced.

Moreover, in Comparative Example 2 illustrated in FIG. 6, to prevent images prepared for the colors from being mixed when the backlight alternately emits light of RGB colors in succession, a black display time is provided when the color of light from the backlight is changed. In this case, it is necessary to drive each pixel 202 at sextuple speed, so power consumption for driving each pixel 202 is increased. Moreover, in the black display period, the light from the backlight is absorbed, so light use efficiency is ½ or less. In addition, light use efficiency or ½ or less is a value at a very high liquid crystal response speed of 2.78 ms, so in the case where the liquid crystal response speed is slower than 2.78 ms, the light use efficiency is further reduced.

Moreover, in Comparative Examples 1 and 2, as a fundamental issue in the field-sequential system, the above-described color breakup phenomenon occurs. To suppress such a color breakup phenomenon, for example, in a device such as a DMD, performing a sextuple-speed drive or the like which is a faster drive is considered, but it is difficult to take similar measures in a liquid crystal which is slow in response.

On the other hand, in the embodiment, for example, as illustrated in FIG. 7, the backlight section 3 and the sub-pixels 20A and 20B in the liquid crystal display panel 2 are driven so as to include backlight-on periods ΔTon1 (a first drive period) and ΔTon2 (a second drive period) which will be described later in one vertical period time-dividedly. First, in a backlight-off period ΔToff, a picture signal D1R for red light is written to the sub-pixel 20A, and a picture signal D1B for blue light is written to the sub-pixel 20B. After that, when the red light source 3R and the blue light source 3B emit light at the same time, magenta (M) light is emitted from the backlight section 3 in the backlight-on period ΔTon1.

More specifically, the backlight-on period ΔTon1 is in a state as illustrated in FIG. 8(A). In other words, red light and blue light are emitted from the backlight section 3, and the red light is selectively modulated in response to the picture signal D1R for red light in the sub-pixel 20A to display a picture by the red light. On the other hand, the blue light is selectively modulated in response to the picture signal D1B for blue light in the sub-pixel 20B to display a picture by the blue light.

Next, in the backlight-off period ΔToff, a picture signal D1G for green light is written to both of the sub-pixels 20A and 20B. After that, the green light source 3G lights up, thereby green light is emitted from the backlight section 3 in the backlight-on period ΔTon2.

More specifically, the backlight-on period ΔTon2 is in a state as illustrated in FIG. 8(B). In other words, green light emitted from the backlight section 3 is selectively modulated in response to the picture signal D1G for green light in both of the sub-pixels 20A and 20B to display a picture by the green light.

Then, such backlight-on periods ΔTon1 and ΔTon2 are included in one vertical period time-dividedly, thereby full-color display corresponding to the picture signals D1R, D1G and D1B for the three primary colors is performed.

At this time, in the backlight-on period ΔTon1, red light and blue light are emitted from the backlight section 3, and in the backlight-on period ΔTon2, green light is emitted from the backlight section 3. Thereby, each primary color light emission period (a lighting-up period) in one vertical period is longer than that in Comparative Examples 1 and 2 (in the field-sequential system in related art). More specifically, aperture ratios for the red light and the blue light are reduced to ½ by the color filters, so the light use efficiency of the red light and the light use efficiency of the blue light are reduced to ½. However, the lighting-up period is increased to 5.56 ms (the response of the liquid crystal is 2.78 ms which is equal to that in related art) to cause an increase in duty ratio. In addition, this effect is more remarkable in the case where the response of the liquid crystal is slow.

Moreover, in the backlight-on period ΔTon2, only green light is emitted, and then modulated in both of the sub-pixels 20A and 20B, so compared to a three-primary-color filter system in related art, the aperture ratio in full-color display is improved. More specifically, the aperture ratio for green light is unchanged, and the period is extended, so efficiency is increased twice or more as high as that in related art. At present, power luminous efficiency of the green LED is approximately ½ of that of each of other color LEDs, so a backlight including green LEDs which is twice as many as other color LEDs such as a backlight including RGGB LEDs is frequently used. Therefore, improving the light use efficiency of the green light is more effective in costs and power than LEDs of other colors.

Further, in the backlight-on period ΔTon1, both of red light and blue light are emitted, so the occurrence of the color breakup phenomenon is prevented. More specifically, when the red light and the blue light are allowed to be emitted at the same time, color breakup between the two colors does not occur. In related art, fluctuations specifically in luminance of G and B are large, but when the red light and the bleu light are emitted at the same time, fluctuations in luminance are prevented. Moreover, even if a frame frequency is unchanged, a period until the same color is displayed is reduced. For example, the period is reduced from 13.89 ms in Comparative Examples 1 and 2 to 11.11 ms.

As described above, in the embodiment, in the backlight-on period ΔTon1, red light and blue light are emitted from the backlight section 3, and in the backlight-on period ΔTon2, green light is emitted from the backlight section 3, so each primary color light emission period (a lighting-up period) in one vertical period is allowed to be longer than that in the field-sequential system in related art, and an increase in duty ratio is allowed. Moreover, in the backlight-on period ΔTon2, only green light is emitted, and the green light is modulated in both of the sub-pixels 20A and 20B, so compared to the three-primary-color filter system in related art, the aperture ratio in full-color display is allowed to be increased. Further, in the backlight-on period ΔTon1, both of red light and blue light are emitted, so the occurrence of the color breakup phenomenon is preventable. Therefore, while enhancing light use efficiency and power efficiency, an improvement in image quality in color display is allowed.

Moreover, in the backlight-on period ΔTon2, the sub-pixels 20A and 20B are collectively driven, so a reduction in a writing time is allowed.

Further, the gate line G is commonly connected to the sub-pixels 20A and 20B in each pixel 20, and the data lines DA and DB are connected to the sub-pixels 20A and 20B, respectively, so even if the number of pixels is doubled, a writing period is prevented from being reduced.

Modifications

Next, some modifications of the invention will be described below. In the modifications, like components are denoted by like numerals as of the embodiment and will not be further described.

Modification 1

FIG. 9 illustrates a timing chart of a method of displaying a picture according to Modification 1. In the modification, in the backlight-on periods ΔTon1 and ΔTon2, black display is performed in response to a picture signal for black display before driving the sub-pixels 20A and 20B in response to the picture signals D1R, D1G and D1B for the primary colors.

More specifically, first, in a state in which liquid crystal cells display black, red data and blue data are written to a sub-pixel including a yellow (Y) color filter and a sub-pixel including a cyan (C) color filter, respectively, and then red light and blue light are emitted at the same time, thereby light from a backlight has the color of magenta. Next, black is written to the liquid crystal cells again, and then the backlight selectively emits green light, and then green image data is written to the sub-pixel including the yellow (Y) color filter and the sub-pixel including the cyan (C) color filter.

Therefore, also in the modification, as in the case of the above-described embodiment, while light use efficiency and power efficiency are enhanced, an improvement in image quality in color display is allowed.

Moreover, the period in which the backlight lights up extends to a ½ frame period, that is, 8.33 ms, so a decline in efficiency due to the duty ratio is largely reduced. In a period in which the liquid crystal cells display black, light from the backlight is absorbed, but a period other than the period in which the liquid crystal cell display black is as long as 5.56 ms, so efficiency is not much reduced. As in the case of the embodiment, light use efficiency of green light is specifically improved.

Modifications 2 and 3

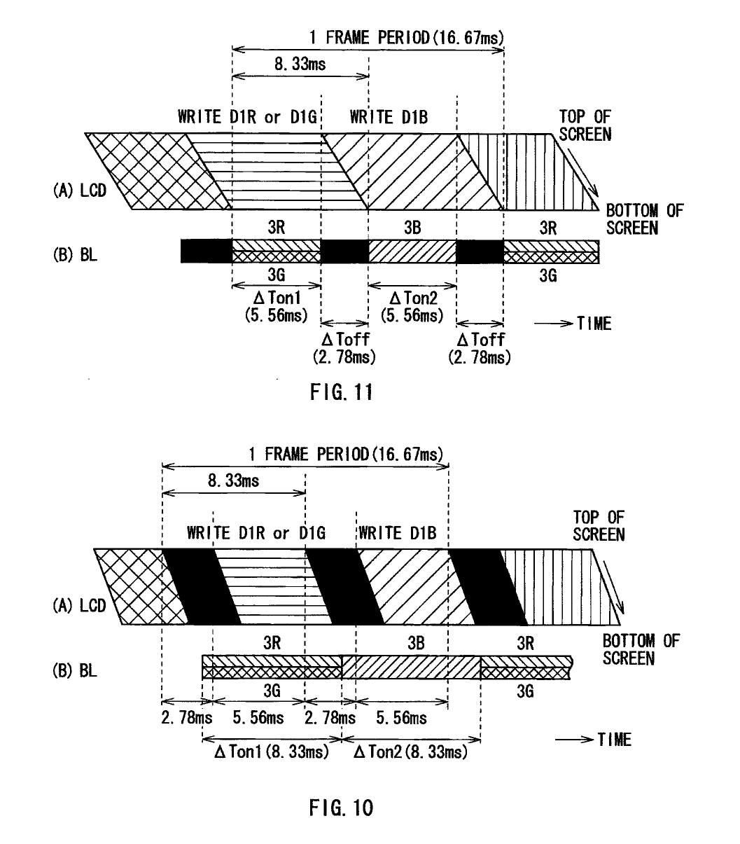

FIG. 10 illustrates a timing chart of a method of displaying a picture according to Modification 2. FIG. 11 illustrates a timing chart of a method of displaying a picture according to Modification 3. In addition, the method of displaying a picture according to Modification 2 corresponds to a modification of the method of displaying a picture according to the above-described embodiment, and the method of displaying a picture according to Modification 3 corresponds to a modification of the method of displaying a picture according to Modification 1.

In the modifications, the first primary light is red (R) light, and the second primary light is blue (B) light, and the third primary light is green (G) light. Moreover, the sub-pixel 20A includes a magenta (M) color filter 23M, and allows at least red light and blue light to pass therethrough. On the other hand, the sub-pixel 20B includes a cyan (C) color filter 23C, and allows at least green light and blue light to pass therethrough.

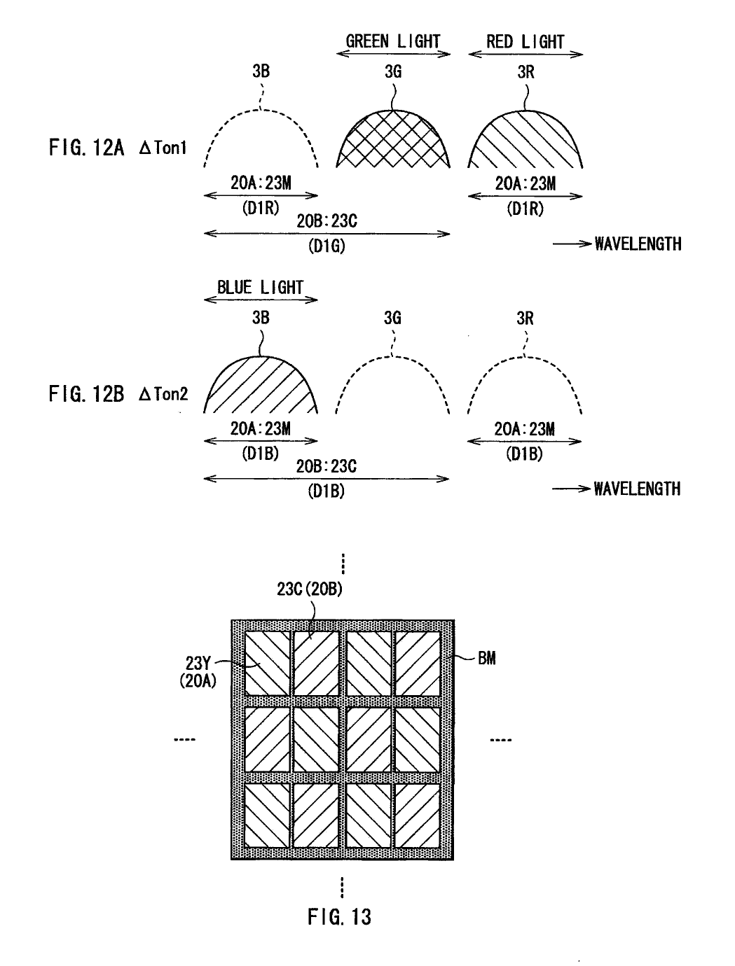

More specifically, in the backlight-on period ΔTon1, as illustrated in FIG. 12(A), yellow (Y) light is emitted from the backlight section 3. Then, red light and green light are emitted from the backlight section 3, and the red light is selectively modulated in the sub-pixel 20A in response to the picture signal D1R for red light to display a picture by the red light. On the other hand, the green light is selectively modulated in the sub-pixel 20B in response to the picture signal D1G for green light to display a picture by the green light.

On the other hand, in the backlight-on period ΔTon2, as illustrated in FIG. 12(B), blue light emitted from the backlight section 3 is selectively modulated in both of the sub-pixels 20A and 20B in response to the picture signal D1B for blue light to display a picture by the blue light.

Thus, also in the modifications, as in the case of the above-described embodiment, while light use efficiency and power efficiency are enhanced, an improvement in image quality in color display is allowed.

Moreover, color breakup between green and red both of which have high visibility is suppressed, so an effect of suppressing color breakup is further improved.

Modification 4

FIG. 13 is a plan view of a configuration example of a color filter according to Modification 4. In the modification, in the liquid crystal display panel 2, the sub-pixels 20A and 20B (the color filters 23Y and 23C) are arranged in a staggered fashion.

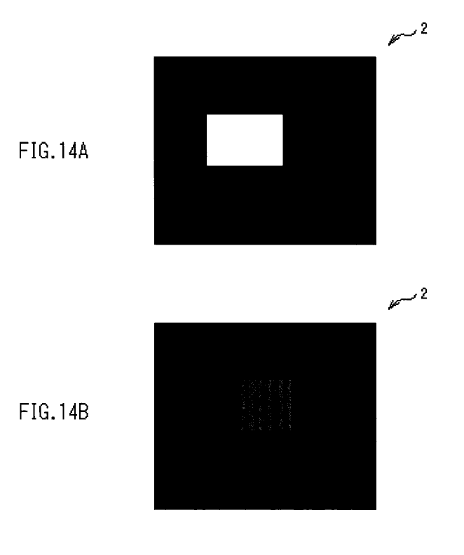

Thereby, in the modification, the occurrence of a vertical streak phenomenon which will be described below is preventable. In other words, the vertical streak phenomenon in which, for example, as illustrated in FIG. 14A, vertical streaks are not observed in white light, but, for example, as illustrated in FIG. 14B, vertical streaks are easily observed at the instant of emitting red light and blue light is preventable. In addition, in the invention, the width of the pixel is larger than a pixel in related art, so the effect is more remarkable.

Modification 5

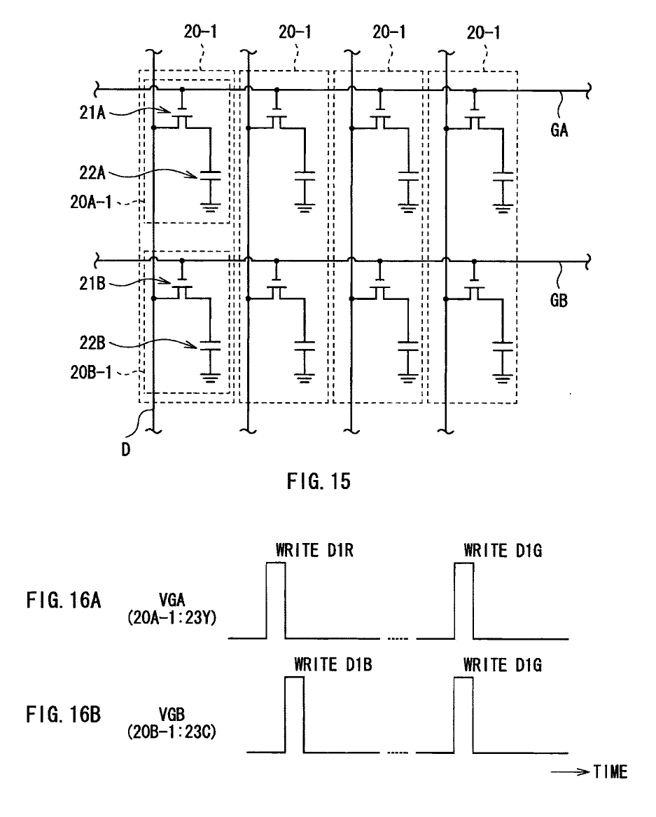

FIG. 15 illustrates a circuit diagram of a configuration of a pixel (a pixel 20-1) according to Modification 5.

In the modification, the gate lines GA and GB are connected to the sub-pixels 20A and 20B in each pixel 20, respectively, and the data line D is commonly connected to the sub-pixels 20A and 20B.

Thereby, in the modification, the cost of the gate driver 52 is approximately ⅓ of the cost of the data driver 51, so the modification has an effect of reducing costs.

In addition, it is feared that a writing period is reduced, so, for example, as illustrated in FIG. 16, in the case of a period in which green is written, two gate lines GA and GB are preferably selected at the same time to gain the writing period.

Although the present invention is described referring to the embodiment and the like, the invention is not limited thereto, and variously modified.

For example, the color of the color filter arranged on each of the sub-pixels 20A and 20B, and the color of light emitted from the backlight section 3 in each of the backlight-on periods ΔTon1 and ΔTon2 are not limited to the colors described above, and a combination of any other colors may be used.

Moreover, the circuit configuration of each pixel is not limited to those described in the above-described embodiment and the like, and each pixel may have any other circuit configuration. For example, a gate line and a data line may be separately connected to each sub-pixel.

The present application contains subject matter related to that disclosed in Japanese Priority Patent Application JP 2008-285305 filed in the Japan Patent Office on Nov. 6, 2008, the entire content of which is hereby incorporated by references.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display comprising:
a light source section allowed to separately emit first primary color light, second primary color light and third primary color light in different wavelength regions;
a liquid crystal display panel including a plurality of pixels arranged in a matrix form as a whole, and modulating each of the first primary color light, the second primary color light and the third primary color light emitted from the light source section in response to a picture signal, each of the plurality of pixels including a first sub-pixel and a second sub-pixel; and
a drive section driving the light source section and each sub-pixel in the liquid crystal display panel in response to the picture signal so as to include a first drive period and a second drive period in one vertical period time-dividedly,
wherein the first sub-pixel allows at least the first primary color light and the second primary color light to pass therethrough,
the second sub-pixel allows at least the second primary color light and the third primary color light to pass therethrough,
in the first drive period, the drive section drives the light source section to separately emit the first primary color light and the third primary color light, and the drive section drives the first sub-pixel and the second sub-pixel in response to a picture signal for the first primary color light and a picture signal for the third primary color light, respectively, and
in the second drive period, the drive section drives the light source section to emit the second primary color light, and the drive section drives the first and second sub-pixels in response to a picture signal for the second primary color light.

2. The liquid crystal display according to claim 1, wherein
the drive section drives the first and second sub-pixels in response to a picture signal for black display before driving the first and second sub-pixels in response to a picture signal for each primary color in the first and second drive periods.

3. The liquid crystal display according to claim 1, wherein
the drive section collectively drives the first and second sub-pixels in the second drive period.

4. The liquid crystal display according to claim 1, wherein
in the liquid crystal display panel, the first and second sub-pixels are arranged in a staggered fashion in the pixels.

5. The liquid crystal display according to claim 1, wherein
a gate line for selecting a pixel to be driven is commonly connected to the first and second sub-pixels in one pixel, and data lines for supplying the picture signal are connected to the first and second sub-pixels in the one pixel, respectively.

6. The liquid crystal display according to claim 1, wherein
gate lines for selecting a pixel to be driven are connected to the first and second sub-pixels in one pixel, respectively, and a data line for supplying the picture signal is commonly connected to the first and second sub-pixels in the one pixel.

7. The liquid crystal display according to claim 1, wherein
the first primary color light is red (R) light, the second primary color light is green (G) light, and the third primary color light is blue (B) light,
the first sub-pixel includes a yellow (Y) color filter,
the second sub-pixel includes a cyan (C) color filter, and
the light source section emits magenta (M) light in the first drive period.

8. The liquid crystal display according to claim 1, wherein
the first primary color light is red (R) light, the second primary color light is blue (B) light, and the third primary color light is green (G) light,
the first sub-pixel includes a magenta (M) color filter,
the second sub-pixel includes a cyan (C) color filter, and
the light source section emits yellow (Y) light in the first drive period.
